(19) United States
(12) Patent Application Publication
(10) Pub. No.: US 2007/0130316 A1
(43) Pub. Date: Jun. 7, 2007

(54) System and method to generate hosting company statistics

(76) Inventor: Bhavin Turakhia, Mumbai (IN)

Correspondence Address: WELSH & KATZ, LTD, 120 S RIVERSIDE PLAZA, 22ND FLOOR, CHICAGO, IL, 60606, US

(21) Appl. No.: 10/935,371

(22) Filed: Sep. 7, 2004

(51) Int. Cl. G06F 15/173

(52) U.S. Cl. 709/224

(57) ABSTRACT

Methods, apparatus and process consistent with the invention as described herein, to use tools and data to generate comprehensive periodical reports and statistics on the consumers, products and vendors in the Web Services industry. Data is gathered through various means, processed (through automated programs and manual assistance) and converted into statistics. These statistics are than formatted into meaningful reports.

### BACKGROUND OF THE INVENTION

The Domain Names and Web Services industry is today a multi-billion dollar industry. There are however no accurate figures, or reports published, which analyze this industry in depth and detail, on a micro and macro level. Web Hosting companies, data-centers, TLD Registries, Domain Name Registrars, are all unaware of various variables such as total market size, Country-wide and worldwide competition, growth of the industry as a whole, Revenue potential etc. A large number of companies have spent time, effort and money to try and capitalize on this industry in an optimistic assumption of making great returns. In any industry there are three entities—namely consumers, vendors and products. Consumers avail of products from vendors. Each industry has different types of products. Consumers purchase these products from a selected vendor based on their preferences.

In the Web Services industry a consumer is typically a website such as ‘http://www.xyz.com’. It consumes various web services such as a domain name, web hosting space, email etc. A vendor is typically one who provides these various services to a consumer (website). For instance, Registries, Registrars, Web Hosting providers, Datacenters, Application Server vendors, Operating System vendors. All these vendors sell services to assist a consumer in setting up and maintaining his web presence. There are various different types of products that a customer avails of for maintaining his web services. For instance the Web Hosting platform for the website maybe Windows or Linux. The Application/Web Server maybe Apache, IIS, Tomcat, Weblogic etc. The Domain Name maybe purchased from any of the over 100 Accredited Registrars. The domain name itself maybe a dotCOM, dotORG, dotINFO etc, and may be registered with any of the Third Level Domain (TLD) Registries worldwide.

The web services market is a continuously growing market with a lot of activity. Newer consumers are born continuously. Old consumers either change their vendors overtime or may even die. By obtaining periodic maps of all consumers and their current product usage worldwide, we can provide significant statistics on trends for the entire industry. The Internet consists of computers worldwide connected through various networks. These machines can communicate with one another using a common protocol (TCP/IP). Each computer is uniquely identified on the Internet using an Internet Protocol (IP) Address. Most humans and systems however choose to reference a computer on the Internet using a domain name, which is an alphabetic combination that maps to an IP Address since an IP Address is comparatively more difficult to remember.

A domain name consists of combinations alphabets, numbers and other allowed characters separated by “dots”. For example valid domain names are ‘www.companyA.com’, ‘support.companyA.com’, ‘jobs.corp.systems.companyA.com’ etc. A domain name consists of the Top Level Domain (TLD), the Second Level Domain (SLD) and the host name. For instance in the above examples “dotCom” is the TLD, ‘companyA.com’ is the SLD, and “www”, “support”, “jobs.corp.systems” are the host names. An SLD represents a unique identity or entity on the Internet. For instance ‘companyA.com’ represents ‘companyA’ Inc. Each SLD can be thought of as a single entity on the Internet. Each SLD in this sense represents a client or a customer who has an Internet presence. There are two kinds of TLDs. The general TLDs refer to generic Top Level Domain Names (gTLDs), that are currently 14 in number, such as dotCom, dotNet, dotOrg, dotBiz, dotInfo etc. Apart from the gTLDs each country is assigned a ccTLD (Country Code TLD) such as dotus for USA, dotin for India, etc. An SLD maybe registered in a gTLD or a ccTLD. In addition, the registry operator A registry operator is a company that maintains each TLD (ccTLD or gTLD) and the root servers of a TLD.

Every SLD is registered with the corresponding registry operator of the TLD it belongs to. Therefore every “dotCom” SLD has to be registered with Verisign (who is the registry operator for dotCom), and every “dotBiz” SLD has to be registered with Neulevel (who is the registry operator for dotBiz). While the ccTLD registry operators are independent, all gTLD registry operators come under the Internet Corporation for Assigned Names and Numbers' (ICANN) domain. Every domain name registered in a gTLD registry must be registered through the respective registrars. Registrars are companies that are authorized by ICANN to register SLDs on behalf of end consumers in the gTLD registries.

A domain name is translated to an IP Address using a Domain Name System (DNS). DNS Servers typically query other DNS Servers to obtain the information they need. There are various DNS Servers worldwide. All DNS Servers maintain authoritative information for a set of domain names. Anyone who wants to find the IP Address of these sets of domain names must query the nameservers that contain the authoritative information on these names. Each TLD and root server is maintained and managed by a registry operator. The root server maintains the list of nameservers that contain authoritative information about all SLDs in that TLD. So for instance the “dotCom” TLD is maintained by Verisign Inc. Verisign maintains root servers that contain information on the nameservers for every SLD that ends in a “dotCom”. So for instance the Verisign root servers would contain information on the nameservers that are authoritative for “companyA.com” etc

Each SLD has various pieces of information that can be gleaned about the SLD through publicly available sources. For instance a complete list of all SLDs belonging to a particular TLD maybe obtained from the registry operator of that TLD through the download of what is known as the Root Zone file. The same root zone file would also contain the nameservers that are authoritative for that particular SLD. Nameservers are typically owned by web hosting companies. Web Hosting companies that provide servers to a client generally also provide the nameserver service for that client. For instance if a website ‘www.mydomain.com’ is hosted with a hosting company, it would typically use nameservers provided by the hosting company for using the web services. A nameserver will also contain the domain name of the web hosting company. For instance Company B's nameservers could be ‘NS.companyB.com’ and ‘NS2.companyB.com’.

While the domain name itself signifies the client, the other variables above signify a vendor and a product. For example, ‘www.xyz.com’ is hosting a Windows based site in the U.S. (‘Product’) with a Hosting Company PQR (‘Vendor1’) whose servers are located in Data center ABC (‘Vendor2’).

There are a few existing technologies that address this problem, though not completely and efficiently. Some companies have created basic maps of the web services industry. However, due to an unorganized process and structure, they are unable to generate periodic reports regularly. SnapNames Inc. and NetCraft Inc. are two companies that generate maps and statistics.

SnapNames Inc. gathers a complete list of all SLDs from various TLD Registries. It then calculates simply the total number of Domain Names registered by each registrar and their gain/loss over the last quarter. However, the shortcomings of the SnapNames service is that they do not analyze the number of variables that are highlighted in this process or have a process that allows calculation of all the statistics across any kind of an industry. Their reports do not provide for competitive analysis and trends.

NetCraft is another company that formulates similar statistics. They collect various data per SLD such as Data center of the SLD, Operating System of the server hosting the SLD, uptime of the SLD etc. NetCraft also has several shortcomings such as their processes do not allow significant scope of rectification and thereby resulting in inaccuracies. Additionally, relationships between vendors i.e. a company maybe a reseller buying domains from the parent hosting company and reselling the same under his name. On doing so, domains may get counted towards both of them. This is a problem that has yet not been dealt with.

Thus, there is a need to adequately and efficiently portray comprehensive statistics that can be used as a reference for both the Hosting Companies as well as consumers.

Whois.sc is another such online statistics portal which displays various data about the number of domain names per nameserver and the gain or loss of domain names per nameserver etc. However whois.sc does not build the relationships between hosting companies and their clients and nor does it calculate statistics about transfer of clients.

### BRIEF DESCRIPTION OF DRAWINGS

FIG. 1 is an illustration of one embodiment of the architecture of the system in which the invention may be implemented

FIG. 2 depicts an embodiment of the Hosting Company Mapping module and its individual modules.

FIG. 3 depicts a flowchart of the process of Data Collection and Formatting, carried out by the Zone File Parsing module of the Hosting Company Mapping module pursuant to an embodiment of the invention

FIG. 4 depicts a flowchart of the process of the TLD Assignment module pursuant to an embodiment of the invention

FIG. 5 depicts the flowchart for rectification of incorrect TLD assignments pursuant to an embodiment of the invention

FIG. 6 depicts the process flow of the Whois Harvester Client pursuant to an embodiment of the invention

FIG. 7 depicts the process flow of the Whois Harvester Server pursuant to an embodiment of the invention

FIG. 8 & FIG. 9 show the process flow of the Auto Parser and the related Assignment module pursuant to an embodiment of the invention

FIG. 10(a), FIG. 10(b) & FIG. 11 show the flowchart of the Manual Parser and the related Assignment Module pursuant to an embodiment of the invention

FIG. 12 depicts the process for requesting an NSGROUP to be added to a Hosting Company pursuant to an embodiment of the invention

FIG. 13 depicts the process for requesting the removal of an NSGROUP from a Hosting Company pursuant to an embodiment of the invention

FIG. 14 represents the process followed by the Statistics generation module to prepare the data tables pursuant to an embodiment of the invention

FIG. 15(a) and FIG. 15(b) represents the process followed by the Statistics Generation module making use of the process of FIG. 15 pursuant to an embodiment of the invention

FIG. 16 represents the process followed by the Statistics Generation module to generate ranking of Hosting Companies.

### DETAILED DESCRIPTION OF THE INVENTION

The present invention may be embodied in several forms, structures and manners. The description provided below and the drawings show an exemplary embodiment of the invention in the client-server environment. Those of skill in the art will appreciate that the invention may be embodied in other forms, structures and manners not shown below. The names and conventions used to represent the tables and other components and processes used in the description represent a preferred embodiment. The invention shall have the full scope of the claims and is not to be limited by the embodiments shown below.

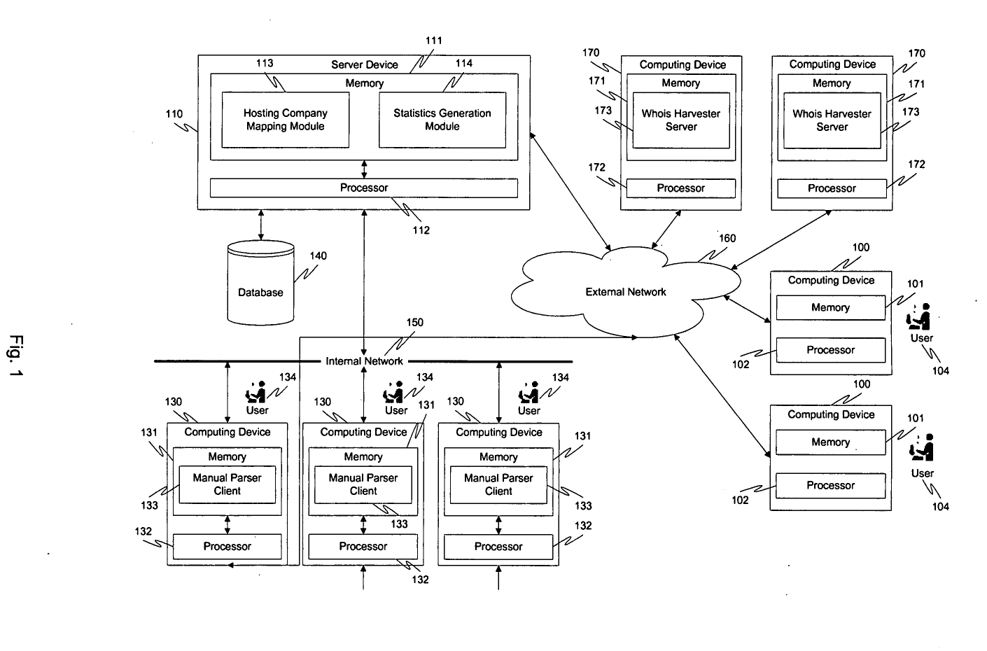

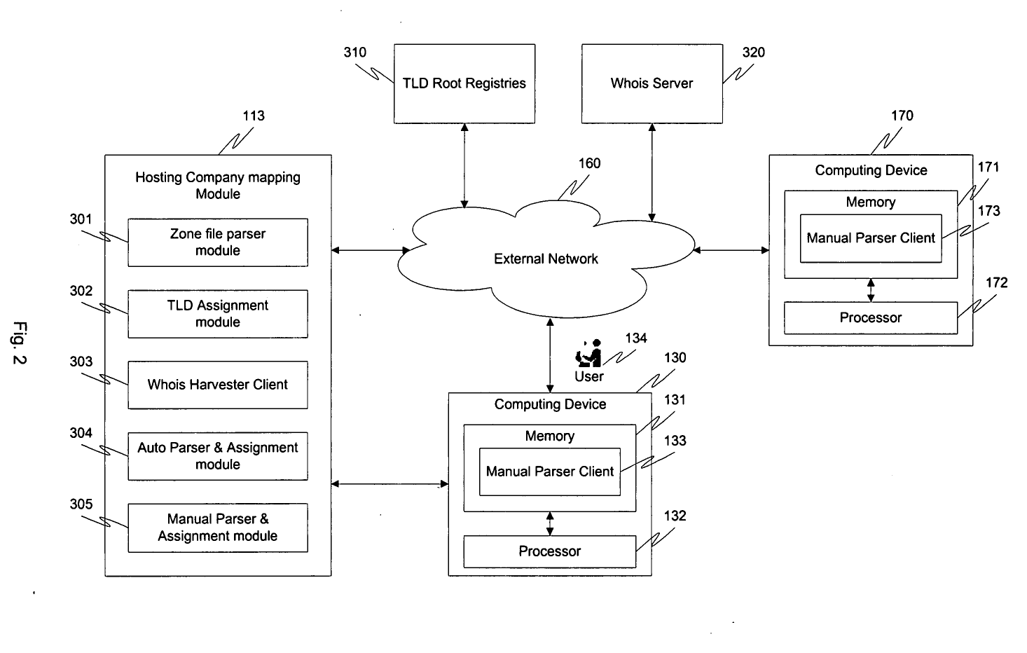

FIG. 1 depicts an exemplary working of an embodiment of system where the invention can be implemented. The system includes multiple computing devices 100 130 170 such as a handheld, PDAs, personal computers etc., a server device 110, a database 140, an internal network 150, and an external network 160, for example, a wide area network such as the Internet or a local area network.

The computing devices 100, 130, 170 include a computer-readable medium 101,131,171, such as a random access memory (RAM), coupled to a processor 102,132,172, a number of additional external or internal devices, such as a mouse, a CD-ROM, a keyboard, and a display. The processor 102,132,172 executes program instructions stored in memory 101, 131,171.

Similar to the computing devices 100, 130, 170, a server device 110 may include a processor 112 coupled to a computer readable memory 111. Server device 110 may additionally include further storage elements, such as a database 140. Users can communicate with each other and with other systems and devices using computing devices 100, 130 coupled to the networks.

An embodiment of the system comprises a long term memory 111 The long-term memory of the server device 111 comprises a hosting company mapping module 113. The hosting company mapping module 113 is responsible for executing instructions to create a regular, ongoing map of hosting companies worldwide and their nameservers using data collected through the external networks 160. This process is implemented using automated as well as manual processes in the Hosting Company Mapping module 113, and other modules such as the Manual Parser client 103 on client devices 100 connected to the internal network 150 and external network 160. Requests for modifying the map created by the hosting company mapping module 113 are made by users 104 using the computing devices 100. The integrity of these modifications are verified using automated and manual workflow processes implemented in the hosting company mapping module 113. The hosting company mapping module 113 is responsible for collecting and formatting the data and storing the data in the form of tables in a database 140.

According to one embodiment of the invention, a statistics generation module 114, is responsible for generating statistics from the tables containing the data that is stored in the database 140. The statistics generation module 114 is also responsible for storing the generated statistics in the form of tables in the database 140

The long term memory 171 of the computing device contains a WHOIS harvester server module 173 which accepts requests in a predetermined protocol such as hypertext transfer protocol (http) etc. from WHOIS harvester clients 303 and then in turn triggers a query to the corresponding WHOIS Server based on the request, and returns the output results to the WHOIS clients.

The Memory 131 of the computing devices within an internal network contains a manual parser client module 133 that queries the database 140 through the server device 110 for NSGROUP records. These records need to be parsed manually and assigned by users 134.

According to an embodiment of the invention, the operation is divided into two macro processes. These processes are hosting company mapping, and statistics generation. The hosting company mapping module is performs an ongoing process creating tables of hosting companies to the corresponding domain names hosted by them. The complete process of mapping and generating tables comprises of various processes, several of them running in parallel, some periodic, and some in serial order. The statistics generation module is responsible for collating and analyzing this data and generating meaningful statistics by comparing snapshots of two different time periods. The statistics generation module can be triggered when hosting company statistics need to be generated.

In the preferred embodiment, the entire process is implemented using a Relational Database Management System (RDBMS). However, in an alternate embodiment, the process may also be implemented in-memory, or in any other form of Database Management System (DBMS), raw text files, or specialized custom data format created for this purpose. Furthermore the instructions to carry out the process may be stored in the Random Access Memory (RAM) of the server device, or alternatively hard-wired into the circuitry of a device, or stored in Read Only Memory (ROM). However, a person skilled in the art will appreciate that the process is not restricted to the implementation described in the present embodiment and can be carried out in various ways to obtain the same or substantially similar results. The embodiment envisages various temporary tables to be created at various levels of implementation. However, a person skilled in the art shall appreciate that these temporary tables are created to facilitate the process and may not be required for implementation. Alternatively, the same process can be carried out entirely in-memory without the need to create several of these temporary tables.

For the purpose of the invention, a TLD shall refer to a TOP Level Domain such as ‘.com’, ‘.net’, ‘co.uk’, ‘co.in’ and the like. An SLD refers to a Second Level Domain Name registered in a TLD Registry and represents a consumer of web services. Nameservers are servers that perform name resolutions for the SLDs and is represented as a domain name, for example ‘ns.mydomain.com’, or ‘dns1.in.mydomain.com’NSGroup refers to a set of nameservers that share the same SLD portion in their domain name. For instance ns.mydomain.com, ns2.mydomain.ccom, ns3.mydomain.com are nameservers belonging to an NSGroup mydomain.com.

A hosting company refers to a web hosting company, which controls a set of NSGroups that typically comprise of a set of nameservers. As per one embodiment of the invention an SLDs whose resolution is handled by the nameservers owned by a particular hosting company can be considered to be a client of the hosting company.

FIG. 2 displays the Hosting Company Mapping module 113 further broken down into its individual modules, and its interaction and role in the entire process. As per one embodiment of the present invention, the hosting company mapping module comprises a Zone file parser 310, a TLD assignment module 302, a Whois harvester client 303, an auto parser and assignment module 304 and a manual parser and assignment module 305. The primary purpose of the hosting company mapping module 113 is to collect continuously, the entire list of SLDs worldwide, the nameservers that are authoritative for those SLDs, the NSGROUPS that the nameservers belong to, the hosting companies that own the NSGROUPS, the countries where the hosting companies are situated and create and maintain a map of the hosting companies to their respective clients.

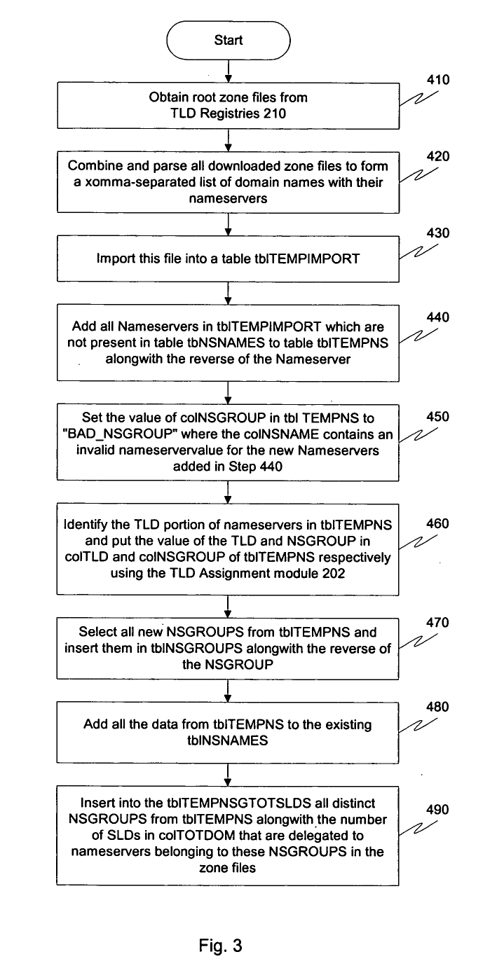

FIG. 3 depicts the flowchart of an exemplary embodiment of the process of data Collection and formatting carried out by the zone file parsing module 301 of the hosting company mapping module 113.

At the first step, 410, the zone file parsing module 301 obtains root zone files from various TLD registries at predetermined intervals. The root zone files contain a list of all domain delegations of a particular TLD. For example, a root zone file from Verisign shall contain a list of all domains registered under the .com TLD with a list of all SLDs and the nameservers that are authoritative for the resolution of these SLDs.

Once the root zone file has been obtained, step 420, the root zone files are combined and converted to form a list of SLDs along with their authoritative nameservers and a temporary table of the list is created, step 430, to faciliate easier manipulation.

Each time a new root zone file is downloaded, step 440, the new set of nameservers that have not been encountered before are added to the list. Every time new nameservers are added, the new nameservers are stored in a temporary table tblTEMPNS. The table tblTEMPNS is just a special temporary table (staging table) created for temporary processing while performing the following steps. A special column in the tblTEMPNS called REVNSNAME stores the nameserver in reverse. For example, the nameserver NS.CompanyA.COM would be saved in the temporary table be MOC.AynapmoC.SN. Such a reverse column, you may note is stored in various other tables such as tblNSGROUPS etc. This process provides for higher efficiency in the matching process. In a typical situation, the matching process is carried out from right to left for each SLD starting with TLD, followed by the SLD, and then the rest of the hostname. In this case, most searches and statistical calculations require SLD's to end with a particular TLD, or NSNAMES to end with a particular NSGROUP. Since the match is made in the latter part of the SLD or nameserver or NSGROUP in question, most tables have an additional column storing the reverse of the string to be searched that accelerates query time exponentially. Eventually all data in this table is transferred to the actual tblNSNAMES table.

Once the matching process has been completed, the new nameservers added to tblTEMPNS that do not comply with RFC host name standards (i.e. the invalid nameservers) are flagged by setting their NSGROUP as a “BAD_NSGROUP” and their TLD as “BAD_TLD”, step 450. A list of all TLDs used worldwide is regularly maintained. The table tblTLDs contains the complete list of all TLD strings that are currently used worldwide. Every nameserver is inspected using a regular expression matching process to match if its TLD matches any TLD string from tblTLDs. In the event that a match is not found, the namserver is assumed to be an invalid nameserver since it does not have a matching TLD in the list and is flagged as an invalid TLD.

As per step 460, the TLD and NSGROUP of the valid nameservers in tblTEMPNS. This process is carried out by the TLD Assignment Module 302, which is described in greater detail further. The NSGROUP and TLD of these nameservers are updated in the tblTEMPNS table. A list of all NSGROUPS is maintained in the tblNSGROUPS table. Every time a new set of root zone files are processed, the new NSGROUPS are identified and the list of updated. The NSGROUPS in the tblTEMPNS that were entered in, Step 460, are selected and the NSGROUPS that were not present in tblNSGROUPS table are added in reverse along with the TLD of the NSGROUP.

As per step 480, the data in tblTEMPNS is shifted to tblNSNAMES once all the processing required has been completed. In Step 490, a table tblTEMPNSGTOTSLDS containing a list of all newly generated NSGROUPS is created with the corresponding number of SLDs that they have in the tblTEMPIMPORT. This table created is then used by the Auto Parser module 304.

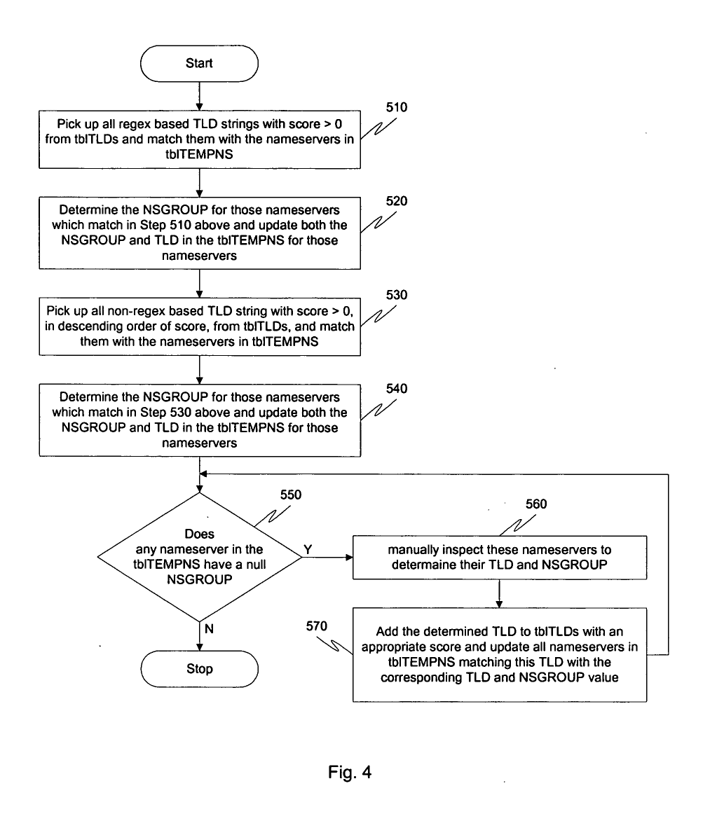

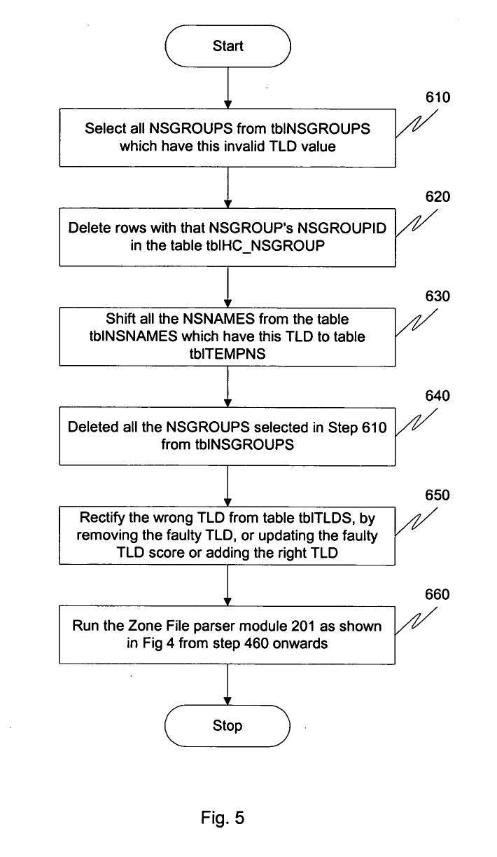

FIG. 4 depicts a flowchart of the process of the TLD Assignment module 302. This process is a detailed flow of the process at Step 460. It is necessary to find out the TLD of an NSNAME before we can determine its NSGROUP. In fact the NSGROUP is simply the TLD plus one extra string immediately to the left of the dot of the TLD. However the task of determining the TLD of an NSNAME is no simple task given the huge variety of TLD Registries that exist. The TLD Assignment module chiefly uses tblTLDS for the purpose of this processing. The tblTLDs contains a set of regular expression (“regex”) and non-regular expression TLD strings with scores assigned to them. Regular expressions are a way of matching and determining whether a given string pattern is present in another string. For example, to determine whether a certain string is a valid domain name there are certain rules that need to be validated. The domain name must consist of strings separated by dots. Each string must contain only alphanumeric characters. Instead of validating these rules one by one it is simpler to write a single regular expression to validate a hostname.

There are two types of TLDs, ccTLDs and gTLDs. While gTLDs are fairly straightforward such as .com, net, org etc, some ccTLDs have significant variety in their TLD. For instance in ‘.us’ the ccTLD is broken down into TLDs per state that are further broken down into territories and categories. Some of the ‘.us’ TLDs are:

ABBEVILLE.SC.US

ABERDEEN.SD.US

ABERDEEN.WA.US

ABILENE.KS.US

ABILENE.TX.US

ABINGDON.VA.US

Due to such variety it becomes impossible to match each TLD one by one. It is easier to write Regular Expressions for all TLDs, which are likely to have varied kinds of TLDs under them rather than perform a match for every TLD one by one. While most of the TLDs may be directly processed without having to resort to regular expressions, some of them have so many combinations that regex processing is the most efficient way of matching them

There is one more aspect to understand about TLD matching, that being the order of matching. This can be better understood with an example. Lets take the ccTLD of India, namely ‘.in’. Any organization or person wishing to register a ‘.in’ domain name may do so in any of the following TLDs, for example, ‘co.in’, ‘net.in’, ‘org.in’, ‘in’. This means that we could possibly have NSNAMES ending in ‘.in’ of the following types ns.somedomain.co.in, dns.anotherdomain.net.in, ns7.onemoredomain.in

The process of identifying the NSGROUP is by identifying the TLD of the nameserver, and appending the first string to the left of the dot of the TLD. In the case of ‘.in’ however, both ‘co.in’ and ‘.in’ are valid TLDs. On manual inspection, in the third nameserver, ns7.onemoredomain.in, the TLD portion is “.in” and the NSGROUP therefore is “onemoredomain.in”. Similarly, for the first Nameserver ‘co.in’ is the TLD portion and therefore somedomain.co.in is the NSGROUP. In the event that the sorting was carried out by an automated process, the sorting would have to be in the descending order of the number of dots in a TLD of a ccTLD. This basically means that for any given list of NSGROUPS an automated process would first need to match the TLDs which have the most number of dots and then go further left and so on. So for instance if an automated process were to try and match the TLDs for the nameservers above it would have to start by attempting to match ‘co.in’, ‘net.in’, and ‘org.in’ before it tried to match ‘.in’. If it attempted to match .in before it had exhausted all the ‘co.in’, ‘net.in’ and ‘org.in’ matches it would wrongly assign ‘.in’ as the TLD even for those which actually have ‘co.in’ in the TLD portion. Therefore a special column called score is added to the table containing the TLDs to determine the order of processing the TLD matching process. The value of score is determined based on the number of dots in the TLD. The processing is then done in the reverse order of score. Some TLDs have a special score of ‘0’ to signify that they will be manually processed. This is done for those ccTLDs whose all TLD combinations are not known. For instance if a ccTLD such as ‘.uk’ also accepts registrations for ‘co.uk’ and ‘org.uk’ and a couple of other TLDs which are not known currently, then ‘.uk’ would get a score of ‘0’ so as to not process ‘.uk’ nameservers without a manual inspection. Once the manual inspection reveals all possible combinations the ‘0’ would change to ‘1’.

As per FIG. 4, the entire set of regular expression based TLD strings with a score greater than 0 from tblTLDS are matched with the set of Nameservers in tblTEMPNS. Wherever a match is found, the NSGROUP is appropriately determined and updated along with the TLD, as per Step 520. Next the entire set of non regular expression based TLDs with score >0 are picked up from tblTLDS in descending order of score, Step 530 and matched one by one against the remaining set of nameservers to determine their NSGROUP and TLD. Each TLD is picked up and all nameservers in tblTEMPNS having an empty NSGROUP value which match this TLD are updated with this TLD and the corresponding NSGROUP. This process continues until the TLD list is exhausted, Step 540. If there are any nameservers that do not have an NSGROUP after this process, Step 550 then these need to be manually inspected and their TLD and NSGROUP determined, Step 560. This TLD must then be added to the table tblTLDS with an appropriate score and all the nameservers in tblTEMPNS, which match with this TLD need to be accordingly updated with the TLD and NSGROUP value, Step 570.

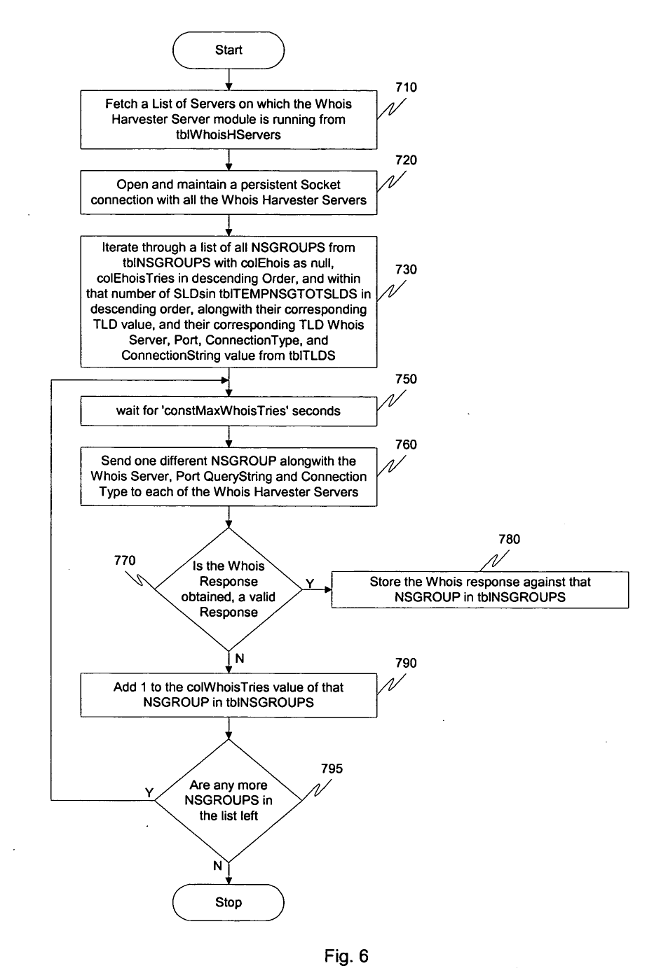

An additional responsibility of the TLD Assignment module is to rectify wrong assignments. A wrong assignment maybe discovered through manual inspection, by a user of the system, or during some other portion of this entire process, such as the WHOIS Harvester module. An invalid TLD assignment can be of two types. A short match or a long match. For instance instead of ‘.co.in’ if the TLD matched was ‘.in’ then it is a short match error. If instead of .in the TLD matched was ‘com.in’. then it is a long match error. In either case, the error will be easily determined since the resulting NSGROUP will not pass through the WHOIS process. For such discovered incorrect assignments the TLD Assignment Module follows the process in FIG. 5.

As depicted in FIG. 5, if an invalid NSGROUP is found due to an invalid TLD by manual inspection or during the WHOIS process then the process shown in FIG. 6 is followed for this invalid TLD value. From the NSGROUPS table select all NSGROUPS, which have this wrong TLD value, Step 610. Remove the assignment of these NSGROUPS so found by deleting rows with the NSGROUP's from the NSGROUPID in the table of NSGROUPS belonging to each Hosting Company, Step 620. The NSNAMES from the tblNSNAMES table that have this TLD are transferred to the tblTEMPNS Step 630. Once this process has been completed, the selected NSGROUPS from tblNSGROUPS, Step 640, are deleted. The wrong TLDs from the table of TLDs are then rectified in the table of TLDs, Step 650, by manual inspection. The possible errors that could occur could be a one or a combination of an incorrect TLD was put in tblTLDS. The entry is rectified by either changing the TLD entry, or dropping the TLD if the TLD does not exist. The other error could be an incorrect score that was entered in the tblTLDS for one or more TLDs resulting in a short or long match. In this case, the error is rectified by changing the score value of the affected TLDs. The last possible error could be a longer TLD was missing because of lack of information thus resulting in a short match. In this case the longer TLD with an appropriate score is inserted. Once these errors have been rectified, the Zone file Parser module 301 is executed.

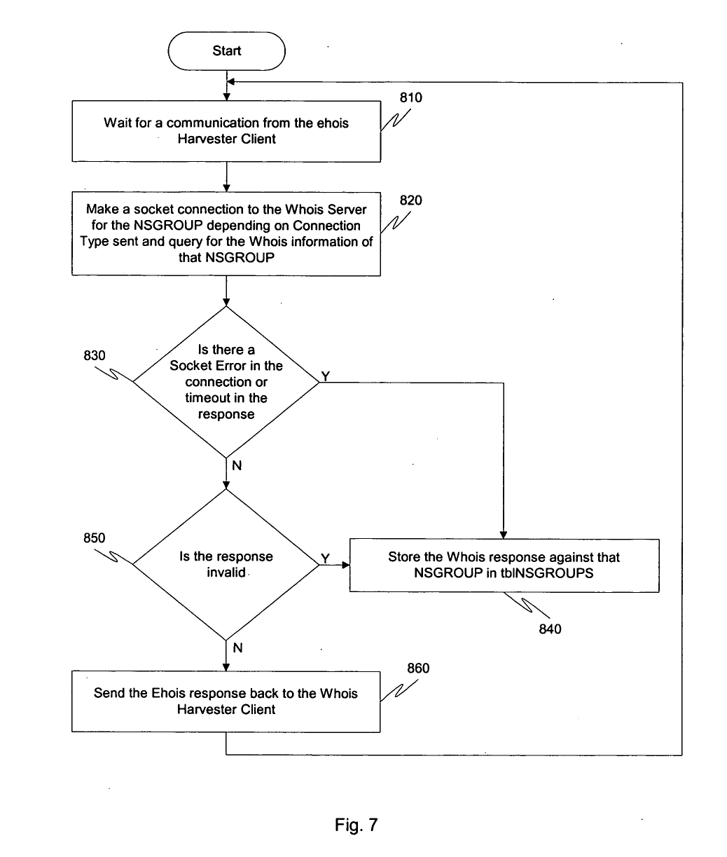

FIG. 6 and FIG. 7 shows the process flow of the WHOIS Harvester Client and WHOIS Harvester Server respectively. The WHOIS Harvester is a simple module, which uses the standard WHOIS protocol to fetch WHOIS information of a given SLD. The module is divided into a WHOIS Harvester Client 303 implemented in the Server device 110, and a WHOIS Harvester Server 173 Implemented in a Computing device 170. The WHOIS Harvester Client 303 communicates with the WHOIS Harvester Server 173 through the Internet (External Network 160).

Worldwide all SLDs registered are associated with contact information. Typically all SLDs have contact information signifying the Owner of the SLD, the administrative contact of the SLD, the technical contact of the SLD and the billing contact of the SLD. This information is typically maintained by the Registry or Registrar or any other authorized body. This body typically maintains a WHOIS Server 320, which accepts a WHOIS query and returns this contact information in a particular format.

The WHOIS Harvester Server 173 accepts queries in a custom protocol from the WHOIS Harvester Client 303, and then based on the query it determines the query it should send to the WHOIS Server 320, which in turn responds with the WHOIS output which the WHOIS Harvester Server 173 sends back to the WHOIS Harvester client 303. While the WHOIS Harvester Client 303 could directly send a query to the WHOIS Server 320 the WHOIS Harvester module is divided into a client-server module so that, using this framework, one can have multiple copies of the WHOIS Harvester Server module 173 running on multiple computing devices 170 spread out geographically. This would result in being able to fire multiple queries in parallel thus speeding up the WHOIS process.

The process followed by the WHOIS Harvester Server and Client is easily understandable from the flowcharts in FIG. 6 and FIG. 7. A few important points to note are as follows:
1. Each query is sent by the client after a wait of ‘constWhoisWaitTime’ seconds (Step 750. This is to ensure that we comply with the standards established by the WHOIS Server. We do not wish to load up any WHOIS Server with excessive querying and therefore the value of ‘constWhoisWaitTime’ is determined to ensure that the querying is well within reasonable limits. As per one embodiment, a reasonable value of ‘constWhoisWaitTime’ could be 30 to 60 seconds.
2. Each time an invalid response is received for a WHOIS query for a particular NSGROUP, a count is maintained for the same. The same NSGROUP is then again tried ‘constMaxWhoisTries’ Step 730. This is because it is possible that there was a network connectivity or server issue during the first WHOIS attempt. However on a subsequent attempt we may be able to obtain a response for the WHOIS Query. As per one embodiment, a reasonable value of ‘constMaxWhoisTries’ could be 3 times

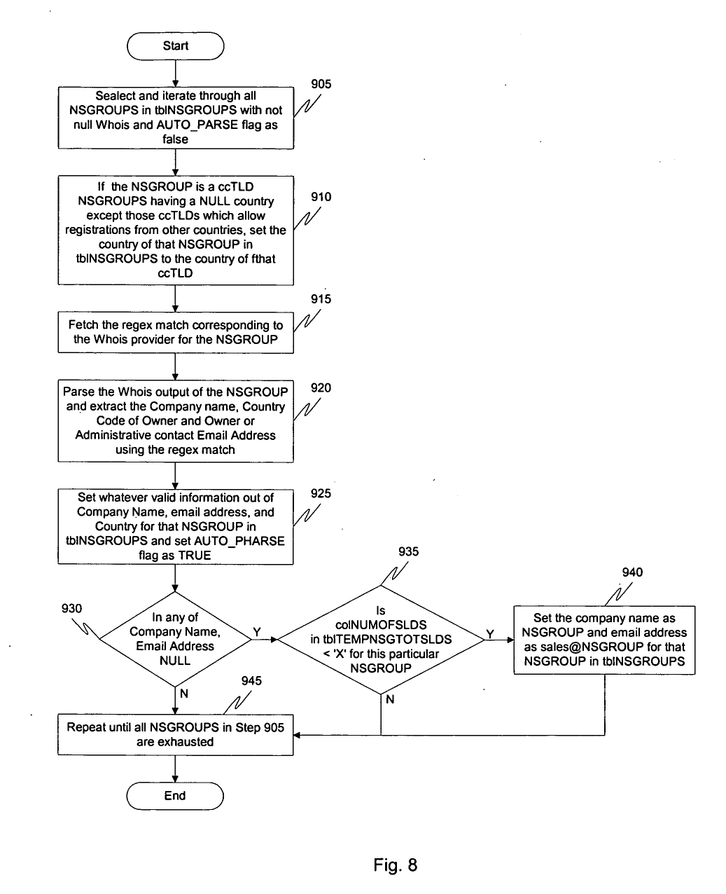

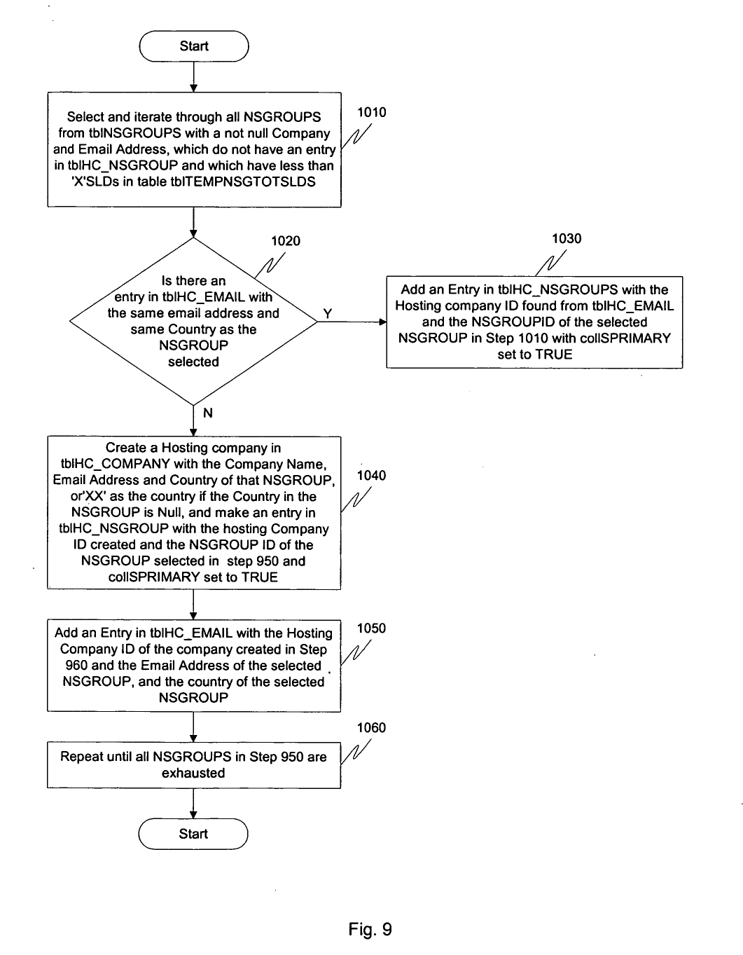

FIG. 8 and FIG. 9 show the process flow of the Auto Parser and Assignment module 304. This module is responsible for automatically parsing the WHOIS Outputs accumulated by the WHOIS Harvester Module, determining the Company Name, and Country of the Owner, as well as the Email Address of the Owner or Administrative Contact of that NSGROUP, and based on this information automatically assigning NSGROUPS to Hosting Companies.

There are various rules used to determine the Hosting Company to which an NSGROUP must be assigned. In one embodiment, the WHOIS Data of any Domain Name contains Owner Contact Information, Administrative Contact Information, Technical Contact Information and Billing Contact Information. It can be assumed that NSGROUPS, which belong to the same Web Hosting Company will have the same email address and country in the Owner or Administrative Contact Information. For instance inspect the WHOIS Output of CompanyA.COM and CompanyA1.COM. The WHOIS output of both of them show that the Owner Contact Email and country are same for both. It can therefore be assumed that the both these NSGROUPS belong to the same owner. The Auto Parser and Assignment module 304 parses the various WHOIS data of all NSGROUPS and based on these and other rules assigns the NSGROUPS to corresponding Hosting Companies.

FIG. 8 depicts the parsing process of this module, which consists of the following steps. Pursuant to one embodiment of the invention, the NSGROUPS table (tblNSGROUPS) contains three columns, namely Company, Email Address and Country. The aim is to fill these three columns in order to determine which Hosting Company the NSGROUP must be assigned to. As per step 905, a particular NSGROUP is selected and iterated through all NSGROUPS in tblNSGROUPS with not null WHOIS and AUTO_PARSE flag as false. Once this process has been completed, if the NSGROUP is a ccTLD NSGROUPS with the country information set to NULL except those ccTLDs that allow registrations from other countries, the country of that NSGROUP in tblNSGROUPS to the country of that ccTLD. For instance ‘.tv’ allows the Registrant to be situated anywhere, and as such it is likely that the Owner of a ‘.TV’ NSGROUP will be in some other country. Except for ccTLDs of this type, all other ccTLDs typically have all their Registrations within their country. Therefore it is assumed that the country of the NSGROUP will be the same as the country of the ccTLD for these ccTLDs.

As per step 915, each type of TLD, and Registrar, is associated with a corresponding WHOIS format. Each of these WHOIS formats are mostly standard, and a regular expression is written to parse each of them specifically and extract the Company Name, Country of Owner, and Owner/Administrative Contact Email address. As per Step 920, the regular expressions corresponding to the WHOIS provider for the NSGROUP are matched and the Company Name, Country of the Owner and the Owner/Administrative Contact Email Address etc. are extracted.

As per step 925, the valid information of the Company Name, email address, and Country for that NSGROUP in tblNSGROUPS are set and the AUTO_PARSE flag is set to TRUE. The AUTO_PARSE flag represents whether the NSGROUP has already passed through the auto-parsing process and therefore does not require to be auto-parsed again. If the extracted data is invalid then typically the WHOIS and the NSGROUP would be sent for manual inspection. However it does not make sense to send every NSGROUP for manual inspection since a majority of them do not host many domains. This can be determined by the table tblTEMPNSGTOTSLDS created by the Zone File Parser Module 301.

Pursuant to an embodiment of the invention, if any of Company Name, Email Address of the NSGROUP cannot be obtained, step 930, and if the SLD column of the tblTEMPNSGTOTSLDS table of newly generated nameservers is less than ‘X’ for the particular NSGROUP, then the company name is set as the NSGROUP, and the default email address is set to sales@NSGROUP for that NSGROUP in tblNSGROUPS table. Here ‘X’ is the threshold value below which it does not make sense to manually inspect NSGROUPS to determine their Email Address. As per one embodiment of the invention a reasonable value for ‘X’ could be 10. For any NSGROUP which hosts less than ‘X’ domains if the auto-parsing process is unable to determine the Company or Email Address, then the Auto-Parser sets the Company as the NSGROUP name itself and the Email address as ‘sales@NSGROUP” assuming that typically most companies have an email address sales@nsgroup.these steps are repeated until all NSGROUPS in Step 910 are exhausted, step 945.

This completes the Auto-parsing phase of this module. After completion of this phase, all those NSGROUPS where the WHOIS can be parsed automatically will now contain an email address and/or a Country value.

As depicted in FIG. 9, once the auto-parsing process has been completed according to one embodiment of the invention, the Auto-Assignment module is given control. The purpose of this entire processing is to end up with creating a map of Hosting Companies and the NSGROUPS that belong to them. The Auto Assignment module follows the flowchart as depicted in FIG. 9 to assign NSGROUPS to Hosting Companies. Typically it is advisable to do the assignment process manually. The Auto Assignment module therefore only assigns NSGROUPS with less than ‘X’ domains. This covers the majority of the NSGROUPS and yet covers only a small minority of total domain names hosted. Only those NSGROUPS that have a valid email address and country value can be assigned.

For every Hosting Company a set of tables are maintained. For example, a table called tblHC_COMPANY contains hosting companies with details of the hosting company is maintained, a table containing a list of email addresses called tblHC_EMAIL contains a list of email addresses, which each Hosting Company is known to use in the Owner or Administrative Contact information of the WHOIS record of their NSGROUP. The table additionally contains the Country of the Hosting Company with a unique constraint on the Email Address and Country combination. The reason for this is if a Hosting Company is actually spread across multiple countries, we allow the geographically separate companies to exist as separate identities, and at the same time share the same email address in the WHOIS for their NSGROUPS. However within the same country, two different Hosting Companies cannot have the same email address in this table. Another table called tblHC_NSGROUPS contains a list of NSGROUPS belonging to each Hosting Company can also be maintained.

As per step 1010, NSGROUPS are selected and the table containing the NSGROUPS is iterated through all NSGROUPS from where the Company and Email Address have already been obtained, which do not have an entry in tblHC_NSGROUP and which have less than ‘X’ SLDs in table tblTEMPNSGTOTSLDS. In short this refers to picking up all NSGROUPS which as yet are not assigned to a Hosting Company in the tblHC_NSGROUPS, and which host less than ‘X’ domains (SLDs). ‘X’ is a predetermined threshold, below which NSGROUPS are automatically assigned to Hosting Companies without a manual inspection. As per one embodiment of the invention, a reasonable value for ‘X’ could be 10.

As per step 1020, the combination of the Email Address and Country in the tblNSGROUP allows us to identify the Hosting Company it should be assigned to. If a Hosting Company is found in the tblHC_EMAIL with the SAME Email Address and Country as in tblNSGROUP for the selected NSGROUP, the NSGROUP is then added under that Hosting Company in tblHC_NSGROUPS, step 1030, with collSPRIMARY set to TRUE or else a Hosting company in tblHC_COMPANY with the Company Name, Email Address and Country of that NSGROUP is created, step 1040, or ‘XX’ as the country if the Country in the NSGROUP is Null, and make an entry in tblHC_NSGROUPS with the Hosting Company ID and the NSGROUP ID of the NSGROUP selected in Step 950 and collSPRIMARY set to TRUE. As per Step 1050 an entry in tblHC_EMAIL with the Hosting Company ID of the company created is added and the Email Address of the selected NSGROUP, and the Country of the selected NSGROUP so that any other NSGROUP with the same email address and country will get assigned to the same Hosting Company. The process from step 1020 is repeated until all NSGROUPS in have been exhausted.

The collSPRIMARY column maintains the assignment type of the NSGROUP. An NSGROUP can actually be assigned to multiple Hosting Companies, thanks to the processes of our system. What this means is that, counts for those domains hosted on nameservers belonging to such an NSGROUP that is assigned to two Hosting Companies will be treated for both of them. For example, a Hosting Company ABC. ABC has a Reseller who has his own NAMESERVERS, NS.RESELLER.COM and NS2.RESELLER.COM. The domains hosted on these nameservers should count towards the Reseller as well as towards ABC, since they are hosted with ABC as well as the Reseller. In this case the NSGROUP RESELLER.COM would have to be assigned to both the Reseller and ABC. However the actual ownership of the NAMESERVER is that of the Reseller. This mapping is achieved by using the collSPRIMARY column of the tblHC_NSGROUPS table. The row for which the NSGROUP signifies actual ownership, collSPRIMARY contains a value of TRUE. Any other column will contain a FALSE value. There can be only ONE row per NSGROUP with value TRUE. This row signifies the owner of the NSGROUP. This row can be called the Primary Hosting Company of the NSGROUP. In this example RESELLER.COM is the Primary Hosting Company or the primary owner of that NSGROUP. The remaining rows may be called the SECONDARY Hosting Companies, or the secondary owner of that NSGROUP. In this example ABC is the Secondary Hosting Company of that NSGROUP.

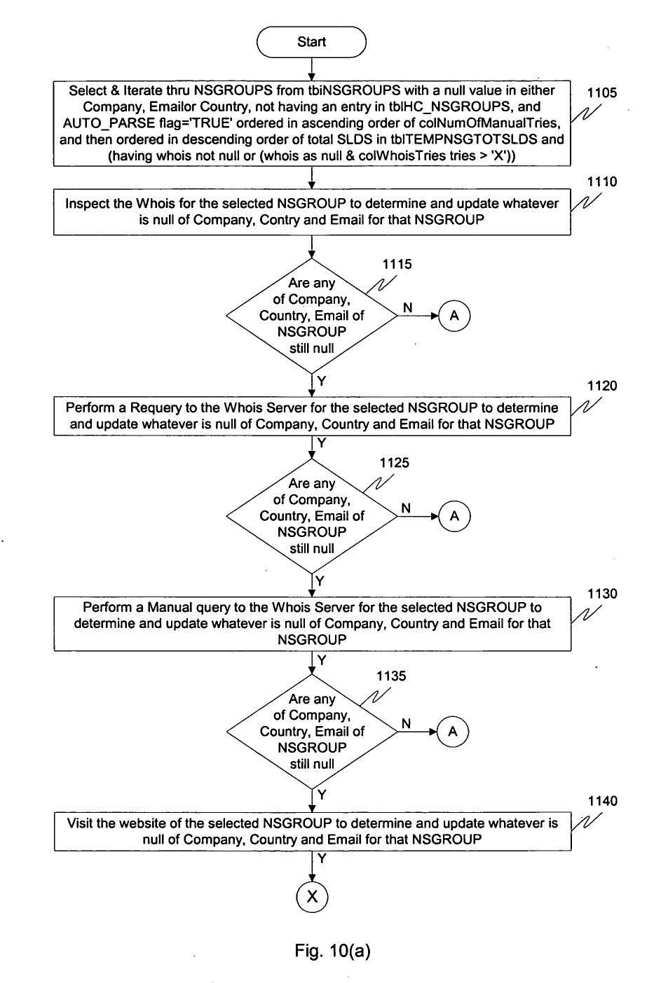

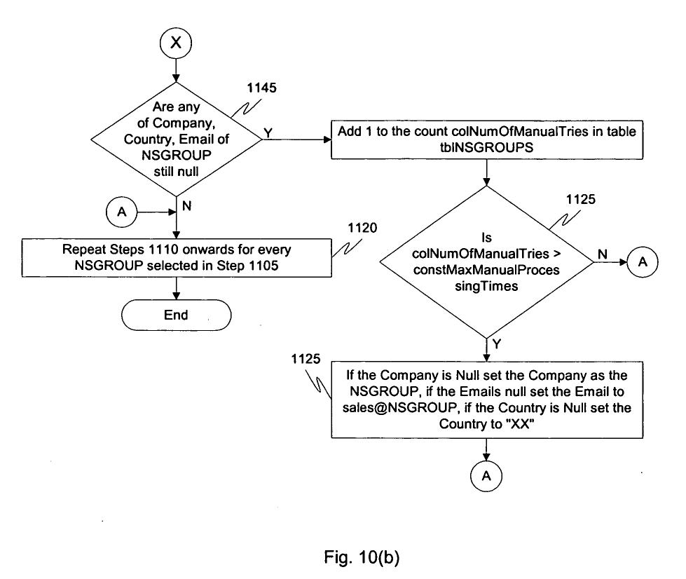

FIG. 10(a) FIG. 10(b) and FIG. 11 show the flowchart of the Manual Parser and the related Assignment Module. The purpose and function of the Manual Parser and Assignment module is quite similar to the Auto Parser and Assignment module. It works on those NSGROUPS that the Auto Parser could not work.

FIG. 10(a) and FIG. 10(b) show the process followed during the Manual Parsing process. This involves setting the Company, Email Address and Country for those NSGROUPS, which the Auto-Parser could not set. As per step, 1105, select and iterate through NSGROUPS from tblNSGROUPS with a null value in either Company, Email or Country, not having an entry in tblHC_NSGROUPS, and AUTO_PARSE flag is set to ‘TRUE’ ordered in ascending order of colNumOfManualTries, and then ordered in descending order of total SLDs in tblTEMPNSGTOTSLDS and having Whois entry that is not null or when the Whois entry is null and the colWhoisTries tries is greater than ‘constMaxWhoisTries’).

This basically selects all those NSGROUPS that have already gone through the AUTO Parsing Module (i.e. AUTO_PARSE flag being set to ‘TRUE’) but yet have some null value, and are not yet assigned (not having an entry in tblHC_NSGROUPS). Even during manual processing it may so happen that at a certain time due to unavailability of a website or a WHOIS lookup a particular piece of information is unavailable. The colNumOfManualTries column maintains a count of the number of times a particular NSGROUP has gone for manual processing. These NSGROUPS are organized such that the NSGROUPS which have gone for manual processing lesser times are prioritized first (ascending order of colNumOfManualTries), and within those, NSGROUPS hosting the most number of domains are processed first (descending order of total SLDS in tblTEMPNSGTOTSLDS). Additionally only those domains are selected for Manual Processing which have a value in their WHOIS, or which have no value in their WHOIS but have been attempted to obtain WHOIS by the WHOIS Harvester Module at least constMaxWhoisTries times. A reasonable value for constMaxWhoisTries could be ‘3’.

As per Step 1110, the WHOIS for the selected NSGROUP are inspected to determine and update whatever is null of Company, Country and Email for that NSGROUP. As per Step 1115, if any of Company, Country, e-mail of NSGROUP are still null, perform a re-query to the WHOIS Server for the selected NSGROUP, Step 1120, to determine and update whatever is null of Company, Country and Email for that NSGROUP. A re-query may help if the previous automated WHOIS Query did not result in a complete Whois output due to any technical issues, or the WHOIS itself was null.

As per Step 1125, if any of Company, Country, e-mail of NSGROUP are still null, a manual query to the Web WHOIS Server for the selected NSGROUP is performed, Step 1130, to determine and update whatever is null of Company, Country and Email for that NSGROUP. Sometimes a port 43 Whois server may not respond, and in that case the process depicted in Step 1120 and Step 1110 will not permit the filling of the remaining data. Therefore it might help to directly visit the website of the particular Registry or Registrar and perform a WHOIS Lookup on their website

As per Step 1135, if any of Company, Country, Email of NSGROUP are still null, the website of the selected NSGROUP is visited, Step 1140, to determine and update whatever is null of Company, Country and Email for that NSGROUP. Typically an NSGROUP may also host the website of the Hosting Company who owns that NSGROUP. For instance ABC.COM points to the website of ABC which is the company that owns the NSGROUP ABC.COM. On inspection of the website from a typical “contact us section” it may be possible to determine the Company, Country, Email for the Hosting Company which owns that NSGROUP

As per step 1145, if any of Company, Country, Email of NSGROUP are still null Step 1150: Add 1 to the count colNumOfManualTries in table tblNSGROUPS and Step 1155: if colNumOfManualTries>constMaxManualProcessingTimes then Step 1160: If the Company is Null set the Company as the NSGROUP, if the Email is null set the Email to sales@NSGROUP, if the Country is Null set the Country to “XX”. The process carried out from Step 1110 is repeated for every NSGROUP selected in Step 1105. Step 1145 to Step 1160 above ensures that a Manual Parser process is attempted on any given NSGROUP for only constMaxManualProcessingTimes times. A reasonable value for constMaxManualProcessingTimes could be ‘3’. If it is found that some of the values of Company, Country and Email Address of a particular NSGROUP are not found despite having tried all the steps above for 3 times, then default values are used for that NSGROUP as described in Step 1160 above.

FIG. 11 depicts the Assignment portion of the module. To reiterate once more the assignment process basically works by first attempting to assign the NSGROUP to an existing Hosting Company based on its Company, Email and Country. If no Hosting Company that seems to be the Hosting Company for this NSGROUP can be found then a new company is created and the NSGROUP is assigned to this new company.

As per step 1205, the module selects and iterates through the NSGROUPS from tblNSGROUPS not having an entry in tblHC_NSGROUPS and having some value in Company, Country and Email Address.

As per Step 1210, a search is performed for a Hosting Company ID in tblHC_EMAIL which has the same Email Address and the same Country as the selected NSGROUP and Step 1215: If there is a Hosting company found in Step 1210 then Step 1220: Make an entry in tblHC_NSGROUPS with that Hosting Company ID and the NSGROUP ID of the selected NSGROUP and collSPRIMARY set to ‘TRUE’, and then continue onwards to Step 1255.

The above steps check the database for any other Hosting Company, which has an entry in the HC_EMAIL table having the same email address and country. Since the HC_EMAIL table contains a list of email addresses which each Hosting Company is known to use in the Owner or Administrative Contact information of the WHOIS record of their NSGROUP and the country it belongs to, therefore if a match is found here then it is quite certain that the NSGROUP belongs to this Hosting Company and the assignment is thus carried out. If no company is found in Step 1210 then as per Step 1225, the Hosting Company ID is searched in tblHC_COMPANY which has the same boiled Hosting Company Name and the same Country as the selected NSGROUP and Step 1230: If there is a Hosting company found in Step 1225 then Step 1235: Display the list of matches, and allow a manual inspection of whether the NSGROUP should belong to any of the displayed Hosting Companies. Step 1240: If the NSGROUP does belong to one of the list of matches then Step 1245: Make an entry in tblHC_NSGROUPS with that Hosting Company ID and the NSGROUP ID of the selected NSGROUP and collSPRIMARY set to ‘TRUE’ and then continue onwards to Step 1255.

In the above steps we are trying to find any other Hosting Company, which may be the owner of this NSGROUP. This is done by matching the boiled Company Name and country of the NSGROUP against the boiled Hosting Company Name and country from tblHC_COMPANY. The process of boiling refers to removing impurities from the Company Name. For example, a Hosting Company by the name of “ABC Pvt. Ltd.” in Country “India”. Now if we have an NSGROUP whose company name is “ABC Pvt. Ltd.” and country is “India” then we can determine that there is a good chance of the NSGROUP belonging to this Hosting Company. However the company names cannot be directly matched since they are not exactly equal. Therefore the company names are boiled by removing additional characters such spaces, dots, special characters, and converting all alphabets to lower case. This results in being able to match both of them and offer this Company as a suggestion. In this fashion any list of companies from the same country as the NSGROUP sharing the same boiled name are displayed, and if any of them seem to be the Hosting Company of the NSGROUP upon manual inspection then accordingly the NSGROUP is assigned to that Hosting Company.

If no company is found in Step 1225, or the NSGROUP does not belong to the listed matches in Step 1240 then Step 1250: Create a Hosting company in tblHC_COMPANY with the Company Name, Email Address and Country of that NSGROUP, and make an entry in tblHC_NSGROUPS with the Hosting Company ID and the NSGROUP ID and collSPRIMARY set to ‘TRUE’. Step 1255: Repeat Steps 1215 onwards for every NSGROUP selected in Step 1205

This largely completes the process of preparing a map of all Hosting Companies worldwide. However there are two more processes over and above these for maintenance of this map. Hosting Companies themselves are allowed to request additions or deletions of NSGROUPS from their list in order to rectify any errors. These processes are screened and managed by firstly adding NSGROUPS. Hosting Companies may choose to add NSGROUPS to its list for the following reasons:
1. It owns a particular NSGROUP and therefore domains hosted on that NSGROUP should count towards its count. However the NSGROUP has been assigned to another Hosting Company. In this case the Requesting Hosting Company would request for Primary Ownership of the NSGROUP, whereby the current Hosting Company would lose the NSGROUP.
2. The Hosting Company has a reseller who has his own Custom Nameservers but hosts all his websites with the Hosting Company. In that case the Hosting Company would request Secondary Ownership of the NSGROUP so that the domains hosted on that NSGROUP would get counted towards both the Hosting Company and its Reseller

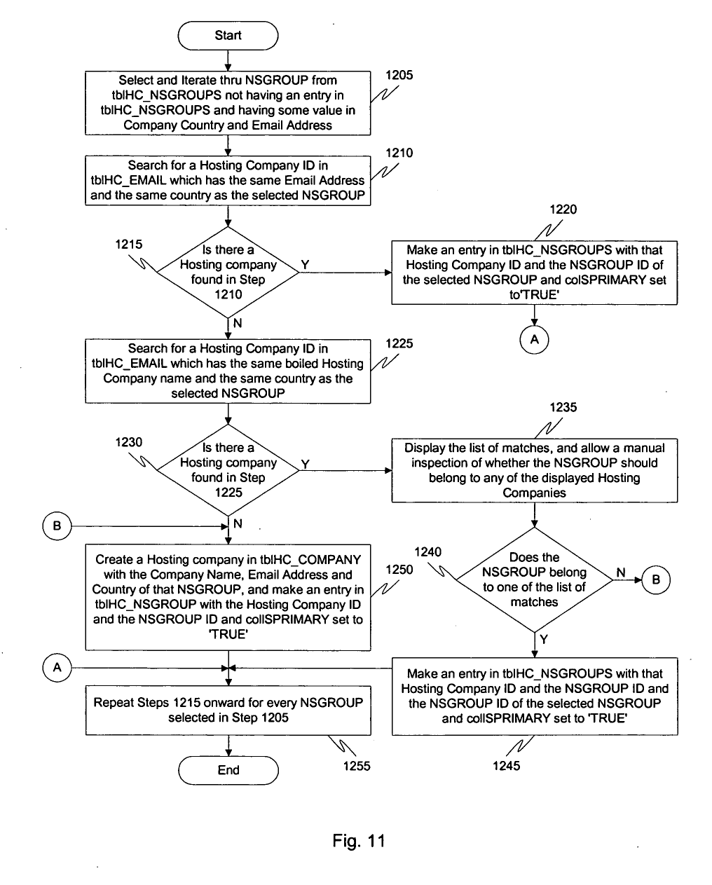

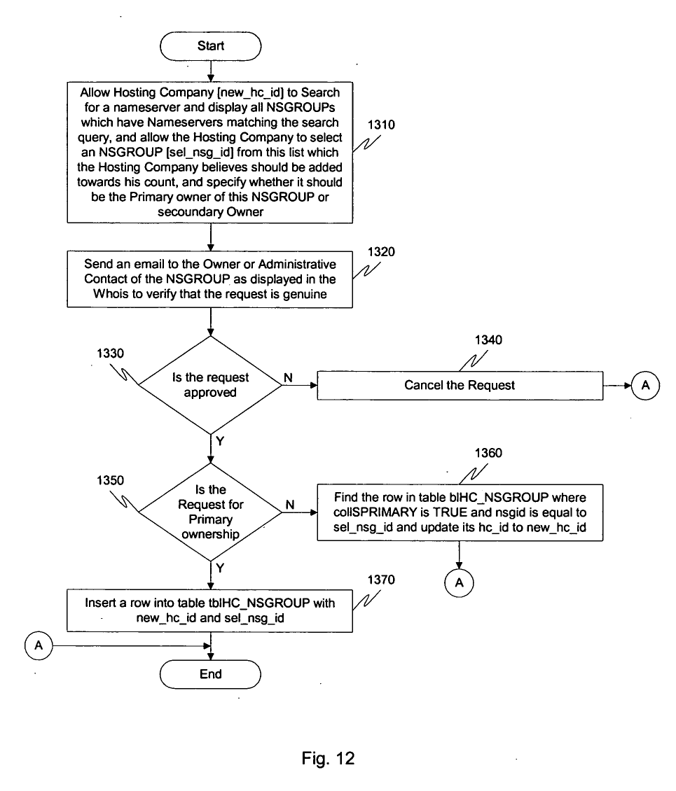

The process for requesting the addition of an NSGROUP and its completion is depicted in FIG. 12.

Step 1310: Allow a Hosting Company [new_hc_id] to Search for a Nameserver and Display all NSGROUPs which have Nameservers matching the search query, and allow the Hosting Company to select an NSGROUP [‘sel_nsg_id] from this list which the Hosting Company believes should be added towards his count, and specify whether it should be the Primary owner of this NSGROUP or the Secondary Owner

Step 1320: Send an email to the Owner or Administrative Contact of the NSGROUP as displayed in the WHOIS to verify that the request is genuine. Any Hosting company can make a request for any NSGROUP to be added to their list. In order to verify the authenticity of the Request we send an email to the Owner or Administrative Contact email address of the NSGROUP as shown in the WHOIS data for that NSGROUP. Step 1330: If the owner or administrative contact does not approve the request, Step 1340: the request is cancelled.

If the request is approved, and Step 1350: if the Request is for a Primary Ownership then Step 1360: Find the row in table tblHC_NSGROUPS where collSPRIMARY is TRUE and nsgid is equal to sel_nsg_id and update its hc_id to the new_hc_id.

In the above steps basically we are modifying the Primary Hosting Company of the NSGROUP in question to the Hosting Company, which placed the request for it. In essence the primary ownership of the NSGROUP is transferred to the New Hosting Company If the Request is approved, and Step 1370: if the Request is for a Secondary Ownership then Step 1370: Insert a row into table tblHC_NSGROUPS with new_hc_id, sel_nsg_id. The above step inserts an additional row in table tblHC_NSGROUPS. This table carries relationships between Hosting Companies and NSGROUPS. This would mean that one more Hosting Company would now get the benefit of the count of all domains on this NSGROUP. A Hosting Company may choose to remove NSGROUPS from its list if it does not want the domains hosted on that NSGROUP to count towards its total.

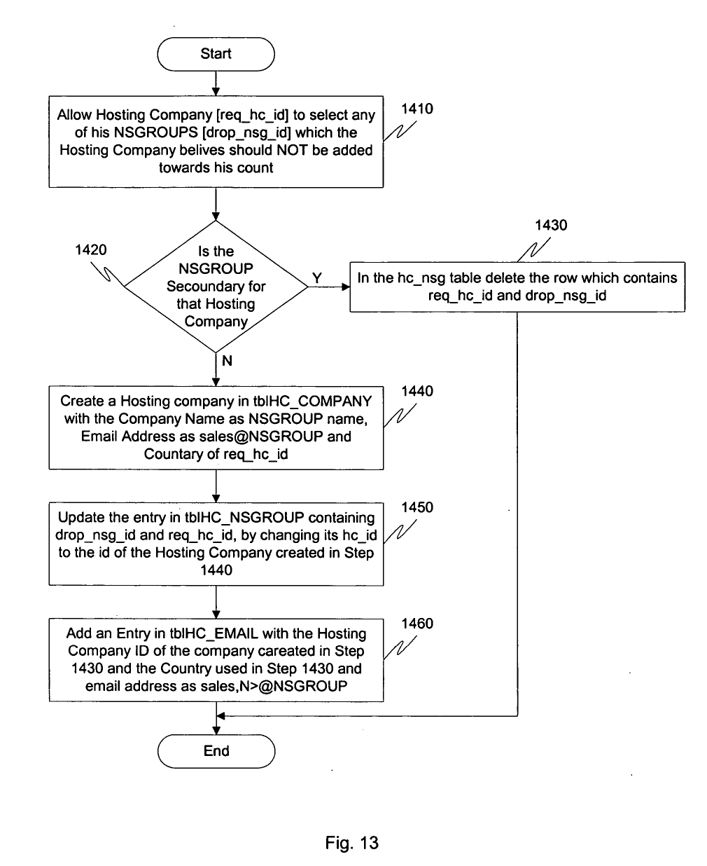

The process for removing an NSGROUP is depicted in FIG. 13.

Step 1410: Allow Hosting Company [req_hc_id] to select any of his NSGROUPS [drop_nsg_id] which the Hosting Company believes should NOT be added towards his count

Step 1420: If the NSGROUP is Secondary for that HC then Step 1430: In the hc_nsg table delete the row, which contains req_hc_id and drop_nsg_id

If the NSGROUP is Primary for that HC then Step 1440: Create a Hosting company in tblHC_COMPANY with the Company Name as NSGROUP name, Email Address as sales@NSGROUP and Country of req_hc_id and Step 1450: Update the entry in tblHC_NSGROUPS containing drop_nsg_id and req_hc_id, by changing its hc_id to the id of the Hosting Company created in Step 1440 and Step 1450: add an Entry in tblHC_EMAIL with the Hosting Company ID of the company created in Step 1430 and the Country used in Step 1430 and email address as sales<N>@NSGROUP

The above steps ensure that if a company chooses to drop NSGROUPS of which it is the Primary Owner then we create a dummy Hosting company with its name as the NSGROUP NAME and assign the NSGROUP to that dummy Hosting Company, since we cannot leave an NSGROUP unassigned. An NSGROUP MUST have a Primary Owner. In Step 1450 the email address used for the entry in the HC_EMAIL table is mentioned as sales<N>@NSGROUP. What this means is that an entry will be attempted to be made in the HC_EMAIL Table with email address sales@NSGROUP. If that fails because there is already an entry there, then another attempt will be made with sales1@NSGROUP and then sales2@NSGROUP and so on until the entry is successful.

This completes the description of the role of the Data Gatherer module. This module is ongoing and running continuously creating a complete map of all Hosting Companies and their respective NSGROUPS. A couple of important aspects to understand at this point in time are

The sets of nameservers belong to a particular NSGROUP i.e. ns.abcd.com’, ns2.abcd.com and ns3.abcd.com all belong to NSGROUP abcd.com. An NSGROUP belongs to a Hosting Company. For e.g. NSGROUP ABC.COM belongs to Hosting Company ABC. This map allows us to determine the clients of a Hosting Company, since domains use a set of nameservers, which belong to a Hosting Company. The map generated by the Data Gatherer module allows for an NSGROUP to relate to more than one Hosting Company. One of these Hosting Companies would be the Primary owner of that NSGROUP while the remaining relationships would be Secondary relationships.

All the flowcharts we discussed until now were with respect to preparing and maintaining a dynamic map of all Hosting Companies and their corresponding. nameservers. This dynamic map allows us to calculate statistics between any two periods. In order to do this we must prepare a map of all domains and their hosting companies for any two given periods, and then run various comparison queries between them

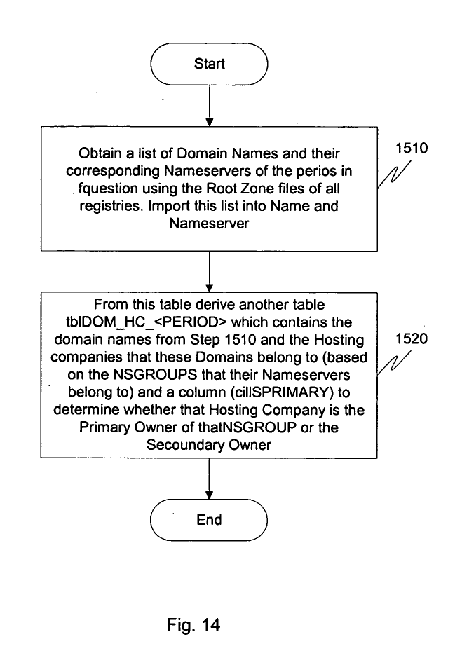

FIG. 14 represents the process followed by the Statistics generation module to prepare the data tables.

Step 1510: Obtain a list of Domain Names and their corresponding Nameservers of the period in question using the Root Zone files of all Registries. Import this list into a table containing columns Domain Name and Nameserver Step 1520: From this table derive another table tblDOM_HC_<PERIOD> which contains the domain names from Step 1510 and the Hosting Companies that these Domains belong to (based on the NSGROUPS that their Nameservers belong to) and a column to determine whether that Hosting Company is the Primary Owner of that NSGROUP or the Secondary Owner. This step uses the table created in Step 1510, and inspects the Nameservers of a Domain Name. Then determines the NSGROUP that each Nameserver belongs to. Then it determines all the Hosting Companies which each of those NSGROUPS, and makes one entry for each of those Hosting Companies in the tblDOM_HC_<PERIOD>. One or more of these rows for that domain name would contain a Hosting Company, which is the Primary Owner of the NSGROUP.

The <PERIOD> signifies the period for which this table represents data. In this fashion multiple tables can be created and compared against one another to generate valuable statistics. For instance a tblDOM_HC_MARCH and a tblDOM_HC_APRIL could be compared to generate a monthly statistics report for a set of Hosting Companies

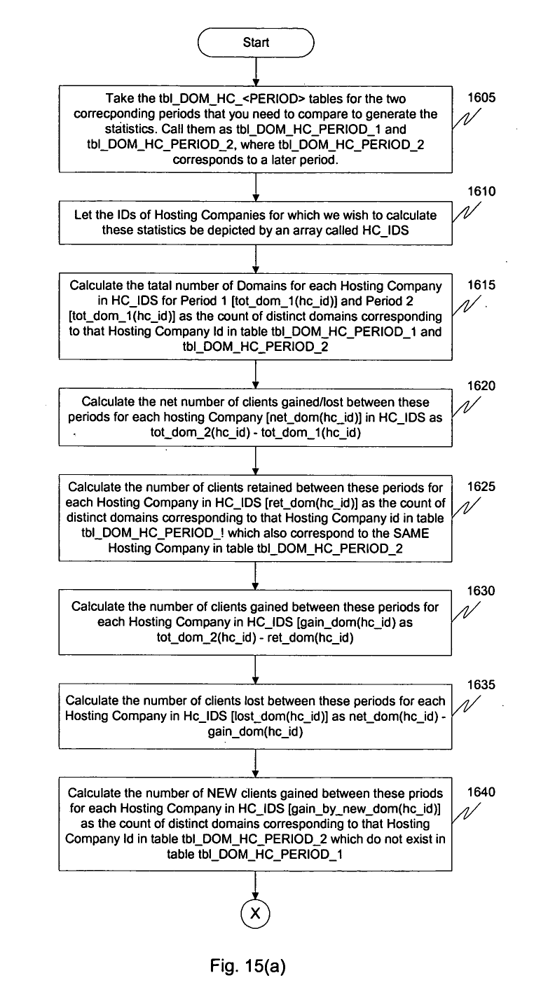

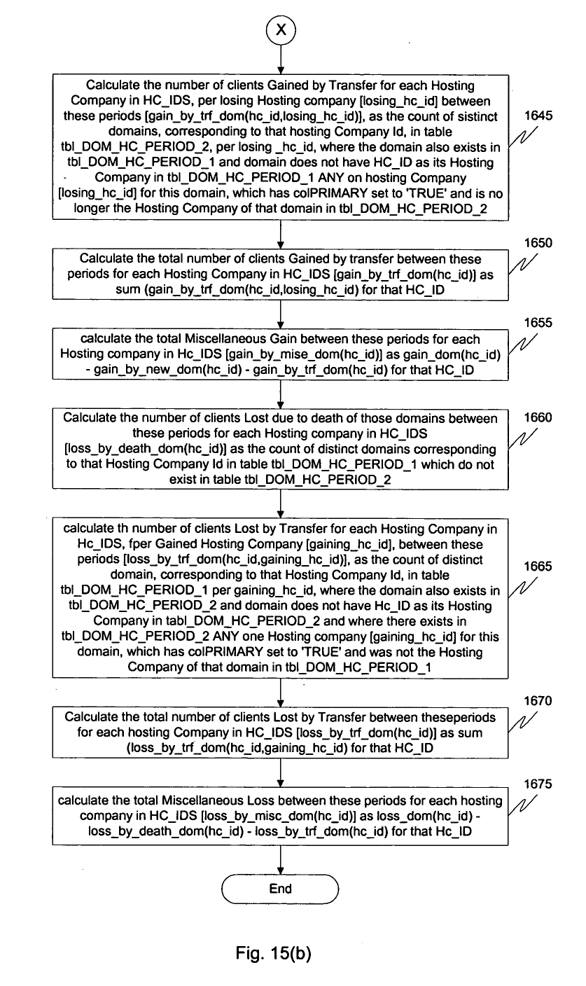

FIG. 15(a) and FIG. 15(b) represents the process followed by the Statistics Generation module to generate statistics by comparing any two tables of different periods generated using the flowchart in FIG. 14.

Step 1605: Take the tbl_DOM_HC_<PERIOD> tables for the two corresponding periods that you need to compare to generate the statistics. Call them as tbl_DOM_HC_PERIOD_{—}1 and tbl_DOM ‘_HC_PERIOD_{—}2, where tbl_DOM_HC_PERIOD_{—}2 corresponds to a later period.

Step 1610: Let the IDs of Hosting Companies for which we wish to calculate these statistics be depicted by an array called HC_IDS

Step 1615: Calculate the total number of Domains for each Hosting Company in HC_IDS for Period 1 [tot_dom_{—}1(hc_id)] and Period 2 [tot_dom_{—}2(hc_id)] as the count of distinct domains corresponding to that Hosting Company Id in table tbl_DOM_HC_PERIOD_{—}1 and tbl_DOM_HC_PERIOD_{—}2

Step 1620: Calculate the net number of clients gained/lost between these periods for each Hosting Company [net_dom (hc_id)] in HC_IDS as tot_dom_{—}2(hc_id)-tot_dom_{—}1 (hc_id)

Step 1625: Calculate the number of clients retained between these periods for each Hosting Company in HC_IDS [ret_dom(hc_id)] as the count of distinct domains corresponding to that Hosting Company Id in table tbl_DOM_HC_PERIOD_{—}1 which also correspond to the SAME Hosting Company in table tbl_DOM_HC_PERIOD_{—}2

Step 1630: Calculate the number of clients gained between these periods for each Hosting Company in HC_IDS [gain_dom(hc_id)] as tot_dom_{—}2(hc_id)-ret_dom(hc_id)

Step 1635: Calculate the number of clients lost between these periods for each Hosting Company in HC_IDS [lost_dom(hc_id)] as net_dom(hc_id)-gain_dom(hc_id)

Step 1640: Calculate the number of NEW clients gained between these periods for each Hosting Company in HC_IDS [gain_by_new_dom(hc_id)] as the count of distinct domains corresponding to that Hosting Company Id in table tbl_DOM_HC_PERIOD_{—}2 which do not exist in table tbl_DOM_HC_PERIOD_{—}1

Step 1645: Calculate the number of clients Gained by Transfer for each Hosting Company in HC_IDS, per losing Hosting Company [losing_hc_id] between these periods [gain_by_trf_dom(hc_id,losing_hc_id)], as the count of distinct domains, corresponding to that Hosting Company Id, in table tbl_DOM_HC_PERIOD_{—}2, per losing_hc_id, where the domain also exists in tbl_DOM_HC_PERIOD_{—}1 and domain does not have HC_ID as its Hosting Company in tbl_DOM_HC_PERIOD_{—}1 and where there exists in tbl_DOM_HC_PERIOD_{—}1 ANY one Hosting Company [losing_hc_id] for this domain, which has colPRIMARY set to ‘TRUE’ and is no longer the Hosting Company of that domain in tbl_DOM_HC_PERIOD_{—}2

Step 1650: Calculate the total number of clients Gained by Transfer between these periods for each Hosting Company in HC_IDS [gain_by_trf_dom(hc_id)] as sum (gain_by_trf_dom(hc_id’, losing_hc_id)) for that HC_ID

Step 1655: Calculate the total Miscellaneous Gain between these periods for each Hosting Company in HC_IDS [gain_by_misc_dom(hc_id)] as gain_dom(hc_id)-gain_by_new_dom(hc_id)-gain_by_trf_dom(hc_id) for that HC_ID

Step 1660: Calculate the number of clients Lost due to death of those domains between these periods for each Hosting Company in HC_IDS [loss_by_death_dom(hc_id)] as the count of distinct domains corresponding to that Hosting Company Id in table tbl_DOM_HC_PERIOD_{—}1 which do not exist in table tbl_DOM_HC_PERIOD_{—}2

Step 1665: Calculate the number of clients Lost by Transfer for each Hosting Company in HC_IDS, per Gaining Hosting Company [gaining_hc_id], between these periods [loss_by_trf_dom(hc_id, gaining_hc_id)], as the count of distinct domains, corresponding to that Hosting Company Id, in table tbl_DOM_HC_PERIOD_{—}1, per gaining_hc_id, where the domain also exists in tbl_DOM_HC_PERIOD_{—}2 and domain does not have HC_ID as its Hosting Company in tbl_DOM_HC_PERIOD_{—}2 and where there exists in tbl_DOM_HC_PERIOD_{—}2 ANY one Hosting Company [gaining_hc_id] for this domain, which has colPRIMARY set to ‘TRUE’ and was not the Hosting Company of that domain in tbl_DOM_HC_PERIOD_{—}1

Step 1670: Calculate the total number of clients Lost by Transfer between these periods for each Hosting Company in HC_IDS [loss_by_trf_dom(hc_id)] as sum (loss_by_trf_dom(hc_id, gaining_hc_id)) for that HC_ID

Step 1675: Calculate the total Miscellaneous Loss between these periods for each Hosting Company in HC_IDS [loss_by_misc_dom(hc_id)] as loss_dom(hc_id)-loss_by_death_dom(hc_id)-loss_by_trf_dom(hc_id) for that HC_ID

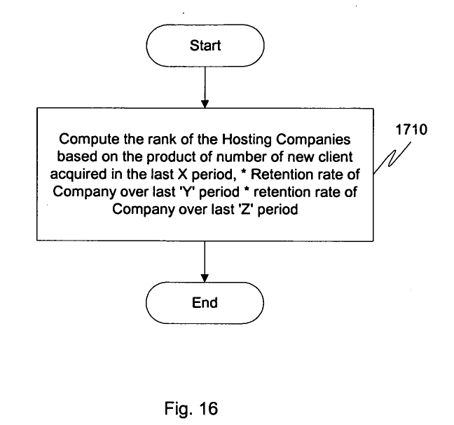

FIG. 16 represents the process followed by the Statistics Generation module to generate ranking of Hosting Companies.

Step 1710: Compute the rank of the Hosting Companies based on the product of number of new clients acquired in the last X period, * Retention rate of Company over last ‘Y’ period * Retention rate of Company over last ‘Z’ period. The above formula is carefully determined. There are two attributes that make a good hosting company. Firstly the capability of a Hosting Company to acquire/gain new clients. Secondly the ability of a Hosting Company to retain existing clients. Therefore the product of these values give us a fair idea of the ranking of a Hosting Company. Acquisition of new clients is however not enough. It is important to retain these new clients as well. Therefore The New clients portion of the formula is worked out as Number of Clients gained over the last ‘X’ period multiplied by the Retention Rate over last ‘Y’ period.

For instance lets say that CompanyA acquired 2000 clients in the last quarter. At the same time over the last 1 year CompanyA successfully retained 6000 out of its 10000 clients. The New client acquisition score of CompanyA would then be determined as:
N=2000×(6000/10000)

The above formula is a calculation of the number of clients from these 2000, who will stay with CompanyA for the next one year.

Next we multiply ‘N’ with the retention rate of CompanyA over the last ‘Z’ period in order to get its ranking. Lets assume a suitable value of ‘Z’ is one quarter. Lets also assume that CompanyA retained 11000 out of 12000 clients in the past quarter. The Rank of CompanyA then would be:
R=N×(11000/12000)=(2000×(6000/10000))×(11000/12000)

Note that the two different retention rates appear in the above formula, which also signifies how important retention rate is in the calculation of ranking of a Hosting Company.

The final formula therefore is:
R=Num of New clients over ‘X’ time*Ret rate over ‘Y’ time*Ret rate over ‘Z’time.

Another variant of this formula may be obtained by simply collapsing ‘Y’ to ZERO. This is based on an assumption that all new clients gained are retained at least for the present. This variant gives lesser important to a hosting company's retention rate.

This finishes the set of statistics generation. The figures generated across multiple such periods can be plotted for insight into trends and various charts maybe made out. The entire set of flowcharts from FIG. 14 to FIG. 16 spoke of a single vendor product combination. Using the process described in this invention, statistics and the ranking of hosting Companies with respect to the number of domains hosted by them in each period are calculated. The set of flowcharts from FIG. 1 to FIG. 15 were the processes used to generate a map of Hosting Companies and their associated domains in any period.

The processes are different for different types of Vendors and Products. For instance if one wants to generate a map of all data-centers worldwide and the domains hosted by them, or if one wants to generate a map of all Hosting Companies hosting domains on Windows Servers, then my processes to generate this map will differ slightly in terms of sources of data gathering and map generation. However once a map showing a relationship between a set of Vendors and a set of Customers for a specific Product have been obtained then FIG. 14 to FIG. 16 may be used for any such map to generate statistics and ranking.

For instance if one obtains two tables tblDOM_DC_MARCH and tblDOM_DC_APRIL, both containing the map of Datacenters and the corresponding domain names they host in March and then in April, one can compare both these tables in the exact same way depicted in FIG. 15-17 to generate exactly similar statistics for these periods.

Similarly if one obtains two tables tblDOM_HC_LINUX_MARCH and tblDOM_HC_LINUX_APRIL containing the map of Hosting Companies worldwide and the corresponding Domains hosted by them on Linux Operating System, then one can run the process depicted in FIG. 14 to FIG. 16 and obtain statistics such as business gain, retention, loss, transfer of Linux Hosted domains.

In fact the flowcharts depicted in FIG. 14 to FIG. 16 need not be restricted to the Hosting Industry at all. In any industry if a map of Vendors and Clients for a specific product can be obtained, then the same flowcharts maybe used to calculate the same set of statistics for that industry. For instance if one obtains a list of Vendors and their list of Customers for a specific Product A. Then in another period the list of vendors and Customers for same Product A are obtained. These two lists maybe compared in the exact same fashion to obtain the desired statistics.

This model also takes care of the fact that some vendors may actually be resellers of other vendors, and therefore the count of the clients of the vendors who are resellers should be added for both themselves and their supplier vendors. This is done by allowing a client to be depicted as a client of multiple vendors with the lowest vendor in the chain acting as the primary vendor for that client.

What is claimed is:

1. A method of generating hosting statistics, the method comprising:
generating a first list of name servers;
identifying at least one top level domain name from the first list of name servers;
identifying a second level domain name for each of the name servers based on the corresponding top level domain names, the second level domain names being referred to as a name server group;
generating a second list of associations between the name server group and the corresponding name servers;
generating a third list of entities associated with each name server group where a single name server group belongs to a plurality of entities using at least one of the first or second list;
generating a fourth list of domain names grouped by the name servers, where a single domain name belongs to a plurality of name servers using at least one of the first, second or third lists; and
generating a fifth list of domain names grouped by the name server groups, where a single domain name belongs to a plurality of name server groups, using at least one of the first, second, third or fourth lists;
whereby the at least one of the fourth or fifth lists generated are used to create a sixth list, the sixth list being used to generate hosting statistics.

2. The method of claim 1, wherein the name server groups are assumed to be owned by hosting companies.

3. The method of claim 1, wherein a sixth list of domain names grouped by hosting companies can be generated, where a single domain name is associated with a plurality of hosting companies, using at least one of the first, second, third, fourth or fifth lists whereby at least one of the first, second, third, fourth, fifth or sixth lists generated are used to determine calculate statistics regarding individual hosting companies.

4. The method of claim 3, wherein at least two maps, each at a different instance of time is captured, the difference between the time being referred to as a time interval, the maps being two instances of the sixth list.

5. The method of claim 4, wherein the name servers are stored in reverse to allow for faster identification of the top level domain and processing of the data.

6. The method of claim 4, wherein a number of clients corresponding to each hosting company, in the interval, can be calculated.

7. The method of claim 4, wherein a number of clients gained and lost for each hosting company, in the interval of time, can be calculated.

8. The method of claim 4, wherein a number of clients retained for each hosting company, in the interval of time, can be calculated.

9. The method of claim 4, wherein a number of clients transferred from a first hosting company to a second hosting company, in the interval of time, can be calculated.

10. The method of claim 4, wherein a number of clients whose domain names are no longer active for each hosting company, in the interval of time, can be calculated.

11. The method of claim 4, wherein a number of clients whose domain names were not active in the interval of time, but are active domain names now, for each hosting company, can be calculated

12. The method of claim 4, wherein the rank of a particular hosting company is determined using a number of clients gained in the time interval and a client retention rate in the time interval

13. The method of claim 12, wherein the client retention rate is calculated by dividing the number of clients retained in the interval by the number of clients existing at the beginning of the interval.

14. The method of claim 1, wherein a list of name server groups to hosting companies can be created, a single name server group belonging to a plurality of hosting companies, where a first part of the plurality of hosting companies is the primary owner of the name server group and a second part are secondary owners.

15. The method of claim 14, wherein hosting companies can manually request for assignment of a particular name server group

16. The method of claim 15, wherein the request for assignment further comprises:
inspecting for validity of the hosting company by checking with an authoritative contact of the name server group; and
assigning the hosting company as one of a primary owner or secondary owner for the name server group upon validation.

17. The method of claim 14, wherein herein hosting companies can manually request for removal of a particular name server group.

18. The method of claim 1, wherein the first list of name servers is maintained and updated by obtaining new name servers using root zone files issued by various third level domain name registries.

19. The method of claim 18, wherein invalid name servers are determined by verifying the validity of a hostname using regular expressions.

20. The method of claim 1, wherein the name server group is identified as the second level domain of a name server by combining the name servers top level domain name with the string immediately preceding the top level domain name while rectifying any incorrect creations.

21. The method of claim 20, wherein the top level domain name portion of a name server is identified by:
matching the nameserver against a pattern that can be classified as a regular expression, which can identify the top level domain name portion of the nameserver;
matching the name servers against a list of top level domain names, in a descending order based on the number of dots in the top level domain; and
inspecting manually, such nameservers, whose top level domain is still ambiguous

22. The method of claim 20, wherein the rectification step comprises:
sending a whois request to an appropriate whois server for the corresponding name server group, and inspecting those name server groups for which such information is not received.

23. The method of claim 22, wherein the rectification of an invalid name server group further comprises:
deleting the assignment of the name server group to the hosting company;
deleting the name server group;
rectifying one of the top level domain name used in the matching process, the order of matching the top level domain name with the name servers and adding the top level domain name as a new top level domain name to the list of top level domain names if a new top level domain name is discovered; and
re-processing the name servers with the new top level domain name.

24. The method of claim 23, wherein a process followed for the valid nameserver group further comprises:
storing the whois information received against the name server group;
matching the information received against a regular expression corresponding to the registrar and registry of the name server group;
inspecting manually the information received; and
searching a world wide web to determine an owner name, an owner country and an owner email address of the name server group.

25. The method of claim 24, wherein default information is stored for the owner name, owner country and owner email address of the name server group when such cannot be determined by any other method.
